(19) United States
(12) Patent Application Publication
(10) Pub. No.: US 2025/0066190 A1
(43) Pub. Date: Feb. 27, 2025

(54) METHOD AND SYSTEM FOR THE PRODUCTION OF SYNTHESIS GAS, BY MEANS OF AN OXY-FLAME, FROM VARIOUS SOURCES OF CARBON AND HYDROGEN

(71) Applicant: HYDRO-QUÉBEC, Montréal (CA)

(72) Inventors: Raynald LABRECQUE, Shawinigan (CA); Robert SCHULZ, Sainte-Julie (CA); Ali SHEKARI, Côte-St-Luc (CA); Michel VIENNEAU, Longueuil (CA); Germain LAROCQUE, Beloeil (CA)

(21) Appl. No.: 18/848,649

(22) PCT Filed: Apr. 6, 2023
(86) PCT No.: PCT/CA2023/050479

§ 371 Date: Sep. 19, 2024

(30) Foreign Application Priority Data
Apr. 7, 2022 (CA) 3154398

(51) Int. Cl. C01B 3/34; C01B 3/04; C01B 32/40

(52) U.S. Cl. CPC C01B 3/34; C01B 3/04; C01B 32/40; C01B 2203/062; C01B 2203/1235

(57) ABSTRACT

Method for producing synthesis gas comprising carbon monoxide (CO) and hydrogen (H₂) comprising: feeding an oxidizing stream comprising O₂ and a first reducing stream comprising H₂ into a first zone of a reactor, where the oxidizing stream and/or the first reducing stream comprises CO₂; generating an oxy-flame in the first zone by reaction between O₂ and H₂, and producing a first gas comprising CO H₂Oᵥₐₚₒᵣ by contacting the oxidizing stream and the first reducing stream with the oxy-flame; feeding into the reactor a second reducing stream comprising a second source of carbon comprising a hydrocarbon; generating in a second reaction zone of the reactor of a second gas comprising the synthesis gas, from the first gas coming from the first reaction zone and the second reducing stream by a reaction involving the hydrocarbon.

### TECHNICAL FIELD

The present application relates to a method and system for producing synthesis or reducing gas comprising carbon monoxide (CO) and hydrogen (H₂) from various sources of carbon and hydrogen (H₂). More particularly, the method for producing synthesis or reducing gas uses at least one first carbon source which is CO₂ and at least one second carbon source comprising a hydrocarbon

### STATE OF THE ART

Gaseous mixtures based on carbon monoxide and hydrogen—commonly known as synthesis or reducing gases—are used in the manufacture of a wide range of basic products such as synthetic liquid hydrocarbons and alcohols. In addition, they can be used in the production of reducing gases in the metallurgical industry (for example, the direct reduction of iron oxides).

To produce such gases, which include carbon monoxide (CO), a source of carbon is required to feed the process. The carbon source can come from fossil resources such as natural gas or coal. Using a carbon source and water vapor, a mixture of carbon monoxide and hydrogen can be produced. Within well-known approaches to accomplish this, natural gas reforming techniques and steam gasification of coal can be mentioned.

The fight against climate change will have to involve, among other things, a substantial reduction in greenhouse gas (GHG) emissions, particularly those of CO₂ and methane. At present, considerable efforts are being made to minimize the consumption of fossil resources as a source of energy and also as a basic ingredient in many chemical syntheses. The use of CO₂ as a carbon source in the production of synthesis gas is one approach being considered to reduce these GHG emissions.

CO₂ is found in the ambient air, but also in atmospheric discharges from industrial processes emitting CO₂ (e.g., cement plant, aluminum plant, steel plants, etc.). The process of capturing CO₂ from ambient air, from biogenic sources, or released by industrial processes to recycle it for later use is also known as “Carbon Capture Utilization” (CCU). The CO₂ thus captured can be used as a carbon source for producing synthesis gas for the production of a wide range of products with improved carbon neutrality, i.e., whose production and use cycle involves low net GHG emissions, when CO₂ comes from biogenic sources or ambient air. It is thus possible to produce carbon synthetic fuels that are more carbon-neutral and can be used in existing infrastructures. It is also possible to produce synthesis gases that can be used to formulate reducing gases for the metallurgical industry (e.g., for the direct reduction of metal oxides).

There are several ways to use CO₂ as a basic reagent to provide carbon for the production of synthesis gas. The most practical way consists in converting the CO₂ into carbon monoxide (CO) according to the reaction (A) called “Reverse Water Gas Shift” or RWGS.

CO₂+H₂→CO+H₂O(vapor) (A)

By reacting CO₂ with an excess of hydrogen (H₂), mixtures based on hydrogen and CO can be produced.

Catalytic bed reactors are generally used to carry out the RWGS reaction (A). However, the use of conventional catalysts to carry out reaction (A) is not without certain limitations in relation to the desired conversion rate for CO₂. Indeed, to obtain high conversion rates, high temperatures are required (e.g., over 1200° C.), but the use of conventional catalysts is problematic at high temperature levels.

Another method for producing synthesis gas is based on the combustion of hydrogen with pure oxygen in the presence of an oxy-flame. The oxy-flame generates heat and water vapor, according to reaction (B).

H₂+½O₂→H₂O(vapor)+HEAT (B)

The water vapor generated by the oxy-flame according to reaction (B) and also by the RWGS reaction (A), during the production of synthesis gas, can be considered as a “loss” of hydrogen and have an impact on operating costs. A method that can take advantage of the water vapor generated, using it to produce synthesis gas, would be desirable.

### SUMMARY

According to a first aspect, the present technology relates to a method for producing synthesis gas comprising carbon monoxide (CO) and hydrogen (H₂), the method comprising:
feeding an oxidizing stream comprising oxygen (O₂) and a first reducing stream comprising hydrogen (H₂) into at least a first zone of at least one reactor, where the oxidizing stream and/or the first reducing stream further comprises a first carbon source which is CO₂;
generating an oxy-flame in the first zone by reaction between the oxygen of the oxidizing stream and the hydrogen of the first reducing stream, and producing a first gas comprising at least carbon monoxide (CO) and water vapor (H₂O) by contacting the oxidizing stream and the first reducing stream with the oxy-flame;
feeding into the reactor a second reducing stream comprising a second source of carbon comprising at least one hydrocarbon;
generating in a second reaction zone of the reactor of a second gas comprising the synthesis gas, from the first gas from the first reaction zone and the second reducing stream by a reaction involving the hydrocarbon.

According to one embodiment, the production of the first gas comprising at least carbon monoxide (CO) and water vapor (H₂O), in the first zone, is carried out at a temperature of at least 1000° C. and at most 2400° C.

According to another embodiment, the production of the first gas comprising at least carbon monoxide (CO) and water vapor (H₂O), in the first zone, is carried out at a temperature of between about 1000° C. and about 1900° C.

According to another embodiment, generating the synthesis gas, in the second zone, is carried out at a temperature of at least 700° C. and at most 1500° C.

According to another embodiment, generating the synthesis gas, in the second zone, is carried out at a temperature of between about 700° C. and about 1000° C.

According to another embodiment, generating the synthesis gas, in the second zone, is carried out at a temperature lower than a temperature in the first zone.

According to another embodiment, the oxidizing stream is fed into a lower, central part of the first zone and the first reducing stream is fed into the lower part of the first zone at the periphery of the oxidizing stream.

According to another embodiment, the second gas generated in the second zone comprises synthesis gas and residual CO₂ and the method further comprises recycling a portion of the second gas to the first zone.

According to another embodiment, a portion of the second gas is recycled in the first reducing stream.

According to another embodiment, the method further comprises cooling the portion of the second gas to be recycled, prior to recycling.

According to another embodiment, the method is carried out in a plurality of reactors in parallel, each reactor having the first zone which receives the oxidizing stream and the first reducing stream and where the first gas is produced, and the second zone which receives the second reducing stream and where the second gas is generated.

According to a further embodiment, the reactor comprises a plurality of first zones and a shared second zone, and wherein:
the oxidizing stream and the first reducing stream are fed to each first zone of the plurality of first zones and the first gas is produced in each first zone,
the second reducing stream is fed to the shared second zone that received the first gas produced in each first zone and the second gas is generated in the shared second zone.

According to another aspect, the present technology relates to a system for producing a synthesis gas comprising carbon monoxide (CO) and hydrogen (H₂), the system comprising at least one reactor and said reactor comprising at least one first reaction zone and at least one second reaction zone, wherein:
the first reaction zone is fed with an oxidizing stream comprising oxygen (O₂) and a first reducing stream comprising hydrogen (H₂), where the oxidizing stream and/or the first reducing stream further comprises a first carbon source which is CO₂, and in the first zone an oxy-flame is generated by reaction between the oxygen of the oxidizing stream and the hydrogen of the first reducing stream, to produce a first gas comprising at least carbon monoxide (CO) and water vapor (H₂O) by contacting the oxidizing stream and the first reducing stream with the oxy-flame;
the second reaction zone is fed with a second reducing stream comprising a second carbon source comprising at least one hydrocarbon, to generate in the second reaction zone a second gas comprising the synthesis gas from the first gas from the first reaction zone and the second reducing stream by a reaction involving the hydrocarbon.

According to one embodiment, the first zone is at a temperature of at least 1000° C. and at most 2400° C. during the production of the first gas comprising at least carbon monoxide (CO) and water vapor (H₂O).

According to another embodiment, the first zone is at a temperature between about 1000° C. and about 1900° C. during the production of the first gas comprising at least carbon monoxide (CO) and water vapor (H₂O).

According to another embodiment, the second zone is at a temperature of at least 700° C. and at most 1500° C. during the production of the synthesis gas.

According to another embodiment, the second zone is at a temperature between about 700° C. and about 1000° C. during the production of the synthesis gas.

According to another embodiment, generating the synthesis gas, in the second zone, is carried out at a temperature lower than a temperature in the first zone.

According to another embodiment, the second gas generated in the second zone comprises the synthesis gas and residual CO₂ and the system further comprises means for recycling a portion of the second gas to the first zone.

According to another embodiment, the means for recycling comprises a duct conveying the portion of the second gas to be mixed with the first reducing stream.

According to another embodiment, the system further comprises a device for cooling the portion of the second gas to be recycled, prior to recycling.

According to another embodiment, the first zone and the second zone are each of cylindrical shape.

According to another embodiment, the system comprises a first means for feeding the oxidizing stream into a lower, central part of the first zone and a second means for feeding the first reducing stream into the lower part of the first zone at the periphery of the oxidizing stream.

According to another embodiment, the first means consists of a first central tube and the second means consists of an annular space extending perpendicularly between an outer wall of the central tube and an inner wall of the first zone.

According to another embodiment, the system comprises a third means for feeding the second reducing stream in the second zone.

According to another embodiment, the first zone and the second zone are each cylindrical in shape and the third means consists of an opening formed by an annular space extending between an outer wall of the first zone and an inner wall of the second zone, optionally in an upper region of the first zone and a lower region of the second zone.

According to another embodiment, the system comprises a plurality of reactors in parallel, each reactor having the first zone receiving the oxidizing stream and the first reducing stream and where the first gas is produced, and the second zone receiving the second reducing stream and where the second gas is generated.

According to another embodiment, the reactor comprises a plurality of first zones and a shared second zone, and wherein:
each first zone of the plurality of first zones is fed by the oxidizing stream and the first reducing stream to produce the first gas in each first zone, and
the shared second zone is fed by the second reducing stream and receives the first gas produced in each first zone to generate the second gas in the shared second zone.

According to some aspects, the method and/or system according to the present technology may comprise the following embodiments.

According to one embodiment, the oxidizing stream comprises oxygen and CO₂.

According to another embodiment, the first reducing stream comprises hydrogen (H₂) and CO₂, and optionally water vapor in a H₂O/H₂ ratio from 0 to 1, preferably in a H₂O/H₂ ratio from 0 to 0.5.

According to another embodiment, the oxidizing stream and the first reducing stream each comprise CO₂.

According to another embodiment, only the oxidizing stream comprises CO₂.

According to another embodiment, the CO₂ comes from an industrial waste, is biogenic CO₂ from biogas, is CO₂ captured directly from ambient air or a mixture thereof.

According to another embodiment, the hydrogen present in the first reducing stream results from a water electrolysis reaction.

According to another embodiment, the hydrogen present in the first reducing stream results from a water electrolysis reaction in an electrolyzer which is powered by electricity produced from a renewable source (e.g. produced from solar energy, wind energy, hydraulic energy, biomass or geothermal energy) or nuclear energy.

According to another embodiment, the hydrogen present in the first reducing stream results from a steam reforming reaction of natural gas or methane in a process in which the CO₂ generated is at least partly captured and sequestered.

According to another embodiment, the hydrogen present in the first reducing stream comprises hydrogen resulting from a water electrolysis reaction in an electrolyzer which is powered by electricity produced from a renewable source (e.g., produced from solar energy, wind energy, hydraulic energy, biomass or geothermal energy) or nuclear energy, and hydrogen resulting from a steam reforming reaction of natural gas or methane in a process for which the CO₂ generated is at least partly captured and sequestered.

According to another embodiment, the hydrogen present in the first reducing stream further comprises hydrogen resulting from a methane pyrolysis reaction.

According to another embodiment, the hydrogen, oxygen and CO₂ are fed in the first zone in a H₂/O₂ molar ratio of at least 2, and a H₂/CO₂ molar ratio of least 1.8.

According to another embodiment, the hydrogen, oxygen and CO₂ are fed in the first zone in a H₂/O₂ molar ratio of between 2 and 10, and a H₂/CO₂ molar ratio of between 1.8 and 9.

According to another embodiment, the oxygen and CO₂ are fed in the first zone in a O₂/CO₂ molar ratio of at least 0.5.

According to another embodiment, the oxygen and CO₂ are fed in the first zone in a O₂/CO₂ molar ratio of between 0.5 and 6.

According to another embodiment, generation of the synthesis gas comprises steam reforming the hydrocarbon(s) with the water vapor comprised in the first gas.

According to another embodiment, the second reducing stream further comprises water vapor and the generation of the synthesis gas comprises steam reforming of the hydrocarbon(s) with the water vapor comprised in the first gas and the water vapor comprised in the second reducing stream.

According to another embodiment, the second carbon source comprises a fossil or renewable hydrocarbon.

According to another embodiment, the second carbon source comprises fossil or renewable natural gas.

According to another embodiment, the second carbon source comprises methane.

According to another embodiment, the second carbon source comprises methane from biogas.

According to another embodiment, the second reducing stream further comprises an organic compound derived from biomass.

According to another embodiment, the second reducing stream further comprises a compound of formula C_{α}H_{β}O_{γ} with α varying from 1 to 5, β varying from 2 to 10 and γ varying from 1 to 4.

According to another embodiment, the second reducing stream comprises methane (CH₄) and optionally hydrogen (H₂) in a H₂/CH₄ molar ratio of between 0 and 2.5.

According to another embodiment, the second reducing stream comprises methane (CH₄) and optionally hydrogen (H₂) and a molar ratio between the CH₄ fed and a total amount of H₂ fed in the two zones is between 0.1 and 1.

According to another embodiment, the second reducing stream further comprises hydrogen (H₂).

According to another embodiment, the hydrogen present in the second reducing stream results from a steam reforming reaction of natural gas or methane in a process in which the CO₂ generated is at least partly captured and sequestered.

According to another embodiment, the second reducing stream comprises a quantity of hydrogen to balance the molar composition of the synthesis gas to have H₂/CO≥2 and (H₂—CO₂)/(CO+CO₂)≥2.

According to another embodiment, the second reducing stream comprises methane (CH₄) and optionally water vapor (H₂O), and a molar ratio of water vapor (H₂O) to CH₄ is between 0 and 2.

According to another embodiment, the second reducing stream further comprises water vapor.

According to a further embodiment, the production of carbon monoxide and water vapor in the first zone is carried out in the absence of a catalyst.

According to another embodiment, the generation of the second gas comprising the synthesis gas in the second zone of the reactor is carried out in the absence of a catalyst.

According to another embodiment, the oxygen (O₂) present in the oxidizing stream results from a water electrolysis reaction.

According to another embodiment, the oxygen (O₂) present in the oxidizing stream comes from an air separation unit (ASU).

According to a further aspect, the present technology relates to the use of a synthesis gas produced by the method as defined in the present description or by the system as defined in the present description, for the manufacture of chemical products or fuels.

According to one embodiment, the use enables the manufacture of synthetic hydrocarbons.

According to yet another aspect, the present technology relates to the use of a synthesis gas produced by the method as defined in the present description or by the system as defined in the present description, as a reducing agent for the metallurgical industry.

According to yet another aspect, the present technology relates to the use of a system as defined in the present description for the treatment of gaseous industrial effluents containing CO₂.

### BRIEF DESCRIPTION OF THE FIGURES

FIG. 1 shows a schematic vertical cross-sectional view of a reactor that can be used to perform the method according to one embodiment.

FIG. 2 shows a schematic vertical cross-sectional view of a reactor that can be used to perform the method according to one embodiment in which the oxy-flame extends towards the second zone.

FIG. 3 shows a schematic vertical cross-sectional view of a reactor that can be used to perform the method according to another embodiment.

FIG. 4 shows a schematic vertical cross-sectional view of a system comprising several reactors in parallel, which can be used to perform the method according to another embodiment.

FIG. 5 shows a schematic vertical cross-sectional view of a reactor comprising a plurality of first reaction zones and a shared second zone, which can be used to perform the method according to yet another embodiment.

FIG. 6 shows a bottom view of the reactor of FIG. 5.

FIG. 7 shows a schematic vertical cross-sectional view of a reactor which can be used to perform the present method, and which is used for the examples. The figure shows the general arrangement of tubes for this reactor.

### DETAILED DESCRIPTION

All technical and scientific terms and expressions used herein have the same meanings as those generally understood by the person skilled in the art of the present technology. The definition of certain terms and expressions used are nevertheless provided below.

The term “about” as used in the present document means approximately, in the region of, and around. When the term “about” is used in connection with a numerical value, it modifies it, for example, above and below by a variation of 10% compared to the nominal value. This term can also take into account, for instance, the experimental error of a measuring device or the rounding of a value.

When an interval of values is mentioned in the present application, the lower and upper limits of the interval are, unless otherwise indicated, always included in the definition.

In the present description, the terms “synthesis gas”, “reducing gas” and “syngas” are used interchangeably to identify a gas mixture comprising at least carbon monoxide (CO) and hydrogen (H₂). In some embodiments, the synthesis gas, reducing gas or syngas may comprise CO₂.

The term “stream” is used to describe the different gas streams involved in the production of the synthesis gas in the different zones inside the reactor.

The term “carbon source” describes the chemical compound(s) that are used to provide the carbon that ends up in the synthesis gas produced. Thus, the carbon source provides at least the carbon that ends up in the carbon monoxide (CO) being produced. Different chemical compounds can be used as carbon source. The present method uses at least CO₂ and at least one hydrocarbon (i.e., a compound based essentially on carbon and hydrogen) as the carbon source to produce the synthesis gas. According to some embodiments, the hydrocarbon used as one of the carbon sources is methane (CH₄) or fossil or renewable natural gas (RNG). According to some embodiments, other carbon sources such as organic compounds comprising carbon, hydrogen and oxygen may be used, as will be explained below.

The expressions “electricity from renewable sources” or “electricity produced from renewable sources” refer to electricity produced from solar energy, wind energy, hydraulic energy, biomass or geothermal energy.

The expression “fossil natural gas” as used in this description refers to a mixture of gaseous hydrocarbons (essentially methane) resulting from the natural transformation of organic matter from underground deposits.

The expression “renewable natural gas” (RNG) as used in this description refers to a gaseous fuel also known as biomethane or first-generation RNG, which can generally contain between 55 and 99% methane, produced from biogas resulting from the anaerobic digestion of organic matter.

This document therefore presents an innovative method for producing synthesis gas using at least CO₂ as carbon source and involving an oxy-flame generated by reaction between oxygen and hydrogen. More specifically, the method of producing synthesis gas comprises: feeding an oxidizing stream comprising oxygen (O₂) and a first reducing stream comprising hydrogen into at least a first reaction zone of at least one reactor, wherein the oxidizing stream and/or the first reducing stream further comprises a first carbon source which is CO₂; generating an oxy-flame in the first zone by reaction between the oxygen in the oxidizing stream and the hydrogen in the first reducing stream, and producing a first gas comprising at least carbon monoxide (CO) and water vapor (H₂O) by bringing the oxidizing stream and the first reducing stream into contact with the oxy-flame; feeding the reactor with a second reducing stream comprising a second carbon source comprising at least one hydrocarbon; and generating in a second zone of the reactor a second gas comprising the synthesis gas, from the first gas coming from the first zone and the second reducing stream by means of a reaction involving the hydrocarbon.

As mentioned above, the method uses at least CO₂ as carbon source to produce the synthesis gas. The CO₂ can have various origins. Hence, the method may use CO₂ from industrial waste, biogenic CO₂ from biogas, or CO₂ captured directly from ambient air, e.g., by the Direct Air Capture (DAC) process. In some embodiments, the carbon source comprises CO₂ captured from ambient air or CO₂ from biomass, in which case the carbon is referred to as “carbon neutral” or “biogenic”.

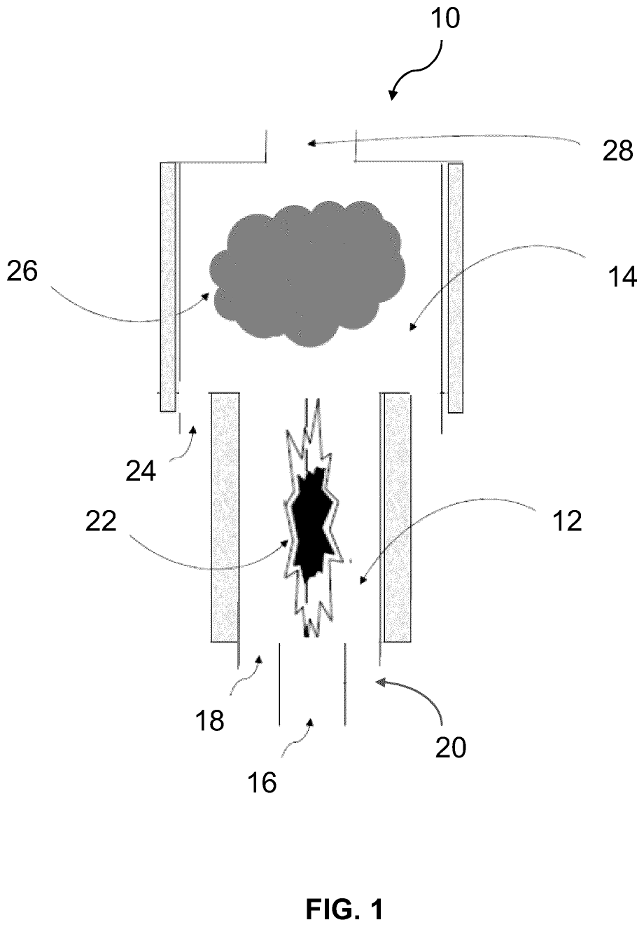

FIG. 1 illustrates the general principle of operation of the method. According to some embodiments, the method can therefore be carried out in at least one reactor 10 having two reaction zones 12 and 14. In some embodiments, the reactor is provided with thermal insulation (not shown in the figures). The second reaction zone can be described as a “downstream” zone of the first reaction zone since the products from the reaction(s) involved in the first zone can serve as inputs for the reaction(s) occurring in the second reaction zone. As will be explained in more detail below, the reactions occurring in the second reaction zone are different from those occurring in the first reaction zone. In the first zone, the reaction(s) involve(s) at least CO₂ as first carbon source and in the second zone, a second carbon source comprising a hydrocarbon is involved. Several sources and types of carbon and/or hydrogen can be used at strategic locations in the reactor. According to some embodiments, the choice of carbon and/or hydrogen source and the location where these gases are fed into the reactor can reduce operating costs. According to some embodiments, the method may be carried out in at least one reactor provided with two reaction zones 12 and 14, an inlet zone 20 and an outlet zone 28. The first reaction zone 12 is supplied with at least two gas streams. The stream 16 fed into the first reaction zone 12 is an oxidizing stream comprising at least oxygen (O₂). The gas stream 18 which is fed to the first reaction zone 12 is a first reducing stream which comprises at least hydrogen (H₂). According to the present method, at least one of the oxidizing stream 16 and the first reducing stream 18 further comprise a first carbon source which is CO₂.

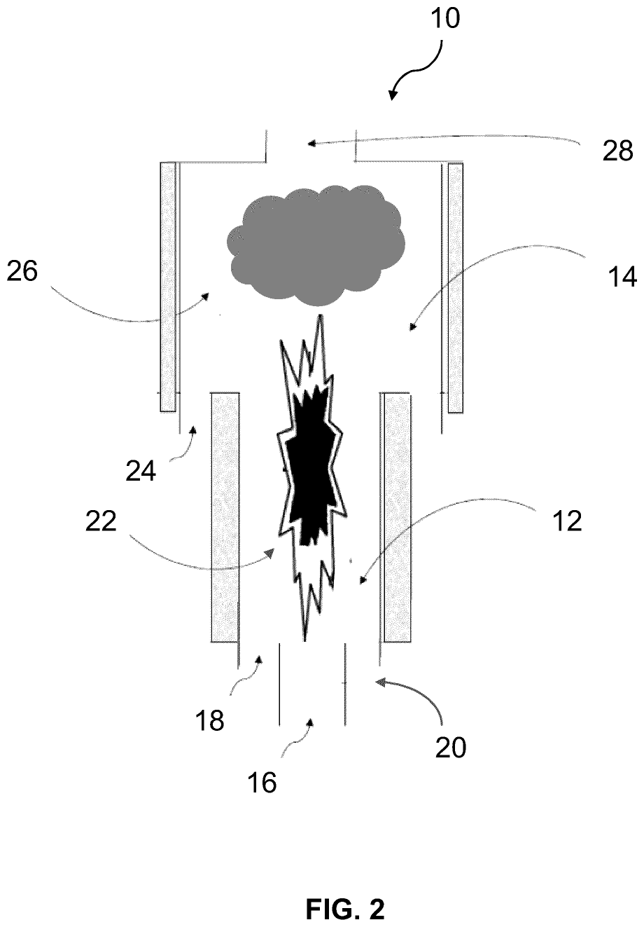

In the first reaction zone 12, the oxy-flame 22 is produced by the combustion of hydrogen (H₂) from the first reducing stream 18 in the presence of oxygen (O₂) from the oxidizing stream 16 according to the aforementioned reaction (B). This flame is bright and radiant and provides the heat required to sustain the reaction which will produce a first gas comprising carbon monoxide (CO) produced from the first carbon source comprising at least CO₂, and also comprising water vapor, according to reaction (A) of the RWGS. Thus, the first gas comprising at least carbon monoxide (CO) and water vapor (H₂O) is obtained by “contacting” the oxidizing stream and the first reducing stream with the oxy-flame. The expression “contacting” according to the present method is understood to mean a distance “d” between the oxidizing stream and the reducing stream which can range from 0 to 50 mm, and preferably from 0 to 30 mm. The distance “d” between the oxidizing stream and the reducing stream in can be 0 mm, 5 mm, 10 mm, 15 mm, 20 mm, 25 mm, 30 mm, 35 mm, 40 mm, 45 mm, 50 mm or any value in between. For example, the distance “d” may be from 0 to 50 mm, from 0 to 40 mm, from 0 to 30 mm, from 0 to 20 mm, or from 0 to 10 mm. In addition, the oxy-flame can generate ionic species and free radicals which can promote the conversion of the carbon source to CO. Thus, it should also be noted that the production of carbon monoxide and water vapor in the first reaction zone 12 can be achieved in the absence of a catalyst such as conventionally used solid catalysts. The combustion of hydrogen (H₂) in the presence of oxygen (O₂) to produce the oxy-flame may be initiated by an ignition device. According to some embodiments, the oxy-flame may make it possible to reach a temperature, in the first reaction zone, of at least 600° C. According to other embodiments, the temperature reached in the first zone 12 is of at least 1000° C. and at most 2400° C. According to some embodiments, the reactor may be equipped with thermal insulation around the reaction zones to minimize heat loss and thus maintain the temperature in the reactor high enough to support the reactions. According to some embodiments, the production of the first gas comprising at least carbon monoxide (CO) and water vapor (H₂O) in the first zone 12 may be carried out at a temperature of between about 1000° C. and about 2300° C., or between about 1000° C. and about 2200° C., or between about 1000° C. and about 2100° C., or between about 1000° C. and about 2000° C., or between about 1000° C. and about 1900° C. The temperature in the first zone 12 may also vary between about 1000° C. and about 1800° C., between about 1000° C. and about 1700° C., between about 1000° C. and about 1600° C., or between about 1000° C. and about 1500° C. In some embodiments, as shown in FIG. 2, the oxy-flame generated in the first zone 12 may extend into the second zone 14 of the reactor. FIGS. 1 and 2 generally show a reactor where the reaction zones 12 and 14 appear one above the other (zones in series), but other configurations are conceivable. Thus, according to some embodiments, the two reaction zones 12 and 14 may be at least partially adjacent to each other (parallel zones). In one embodiment, the oxygen (O₂) used in the oxidizing stream is pure oxygen. By “pure” oxygen, it is understood that this does not necessarily mean 100% purity, but that the oxygen-based mixture substantially comprises O₂ and may be accompanied by certain impurities such as N₂, H₂O, for example. According to some embodiments, the oxygen present in the oxidizing stream 16 results from a water electrolysis reaction. According to certain other embodiments, the oxygen (O₂) present in the oxidizing stream 16 may come from an air separation unit (ASU). It would also be possible to use oxygen that is a mixture of oxygen resulting from a water electrolysis reaction and from an air separation unit.

In some embodiments, the first carbon source, which comprises CO₂, is fed to the first zone of the reactor with the oxygen from the oxidizing stream. In another embodiment, the first carbon source, which comprises CO₂, is fed to the first zone of the reactor with the hydrogen from the first reducing stream. In some cases, a portion of the first carbon source, which comprises CO₂, is fed to the first zone of the reactor with the oxygen from the oxidizing stream and another portion of the first carbon source is fed to the first zone of the reactor with the hydrogen from the first reducing stream. In a preferred embodiment, the first carbon source, which comprises CO₂, is fed to the first zone only with the oxygen from the oxidizing stream.

As previously mentioned, CO₂ may come from various origins. In some embodiments, the CO₂ comes from industrial waste, is biogenic CO₂ from a biogas, or is CO₂ captured directly from ambient air. In some preferred embodiments, the CO₂ used as the first carbon source is biogenic CO₂ from a biogas.

According to an embodiment, the hydrogen required in the present method may be hydrogen qualified as low carbon footprint hydrogen. According to one embodiment, the hydrogen required in the present method to produce the oxy-flame in the first zone, i.e., the hydrogen present in the first reducing stream 18, may, at least in part, result from a water electrolysis reaction. This hydrogen is called “green hydrogen” if the electrolyzer in which electrolysis of the water is carried out is powered by electricity produced from a renewable source, such as solar energy, wind energy, hydraulic energy, biomass or geothermal energy. In some embodiments, the electricity used for the electrolysis of water may be derived from nuclear energy, which is an energy source that does not emit greenhouse gases, and this hydrogen may also be referred to as “pink hydrogen” in the context of the present technology.

According to another embodiment, the hydrogen present in the first reducing stream 18 fed to the first zone of the reactor may be “blue hydrogen”, i.e., hydrogen resulting from a steam reforming reaction of natural gas or methane in a process in which the CO₂ generated is at least partially captured and sequestered.

According to yet another embodiment, the hydrogen present in the first reducing stream 18 fed to the first zone of the reactor may be “turquoise hydrogen”, i.e., hydrogen resulting from a methane pyrolysis reaction.

According to yet another embodiment, the hydrogen present in the first reducing stream 18 fed to the first zone of the reactor may be “pink hydrogen”, i.e., hydrogen resulting from a water electrolysis reaction powered by nuclear energy.

It is also possible to use mixtures of hydrogen from various sources to feed the first zone, to produce the oxy-flame and to form the first gas comprising carbon monoxide (CO) and water vapor (H₂O). Thus, in some embodiments, the first reducing stream 18 may comprise a mixture of green hydrogen and blue hydrogen, or a mixture of green hydrogen and turquoise hydrogen, a mixture of blue hydrogen and turquoise hydrogen, a mixture of green hydrogen, blue hydrogen and turquoise hydrogen.

In some embodiments, the quantities of hydrogen supplied to the first zone 12 (e.g., green, blue, pink and/or turquoise hydrogen) are metered so as to reduce operating costs as much as possible while ensuring that, at the reactor outlet, the molar composition of the synthesis gas satisfies the following equations (C) and (D):

H₂/CO≥2 (C)

(H₂—CO₂)/(CO+CO₂)≥2 (D)

These equations also take into account the fact that additional hydrogen can be introduced into the second zone 14 of the reactor via the stream 24, as will be discussed below, to balance the composition of the synthesis gas.

In particular embodiments, hydrogen, oxygen and CO₂ are supplied to the first zone 12 in a H₂/O₂ molar ratio of at least 2, and a H₂/CO₂ molar ratio of at least 1.8. According to another embodiment, hydrogen, oxygen and CO₂ may be fed into the first zone in a H₂/O₂ molar ratio of between 2 and 10, and a H₂/CO₂ molar ratio of between 1.8 and 9. Thus, hydrogen and oxygen can be fed into the first zone 12 with a H₂/O₂ molar ratio of about 2, about 3, about 4, about 5, about 6, about 7, about 8, about 9, or about 10, or any value in between. In addition, the quantity of hydrogen and the quantity of CO₂ fed into the first zone can be adjusted so that the H₂/CO₂ molar ratio is about 1.8, or about 2, or about 3, or about 4, or about 5, or about 6, or about 7, or about 8, or about 9, or any value between these values. According to some embodiments, oxygen and CO₂ can be supplied to the first zone in an O₂/CO₂ molar ratio of at least 0.5. For example, oxygen and CO₂ may be supplied to the first zone in an O₂/CO₂ molar ratio of between 0.5 and 6. Thus, the quantity of oxygen and the quantity of CO₂ fed to the first zone can be adjusted so that the O₂/CO₂ molar ratio is about 0.5, or about 1, or about 2, or about 3, or about 4, or about 6, or any value in between these values. The H₂/O₂, H₂/O₂ and O₂/CO₂ molar ratios may be adjusted according to the quantity of other gases supplied to the reactor, if any, and according to the desired ratio of CO and H₂ in the final synthesis gas.

It should be noted that in some embodiments, the oxidizing stream 16 and/or the reducing stream 18 may contain, in addition to the inputs described above, a certain quantity of impurities and water vapor. According to some embodiments, the reducing stream 18 may contain water vapor up to a H₂O/H₂ molar ratio of 0.5.

Again, referring to FIGS. 1 and 2, the reactor 10 comprises a second reaction zone 14 generally configured in series with respect to the first zone 12. In some embodiments, as mentioned above and illustrated in FIG. 2 in particular, the oxy-flame 22 which is generated in the first zone may extend into the second zone 14. In this way, the two zones 12 and 14 can also be at least partially parallel to each other. In FIGS. 1 and 2, the streams are fed into each of the reaction zones in a substantially parallel manner. Hence, the first reducing stream and the second reducing stream are substantially parallel in the reactor. However, in other embodiments, it could be contemplated having an “angled” feed of the streams, i.e., the first reducing stream and the second reducing stream could be fed at an angle with respect to each other. In some embodiments, the first reducing stream and the second reducing stream could be fed at a substantially perpendicular angle to each other.

The second reaction zone receives the gas formed in the first reaction zone which comprises at least CO and water vapor generated by reactions (A) and (B) and possibly some residual CO₂ and/or hydrogen H₂. This second reaction zone 14 is further fed by a second reducing stream 24 comprising a second carbon source comprising at least one hydrocarbon. In addition, the reducing stream 24 may comprise water vapor. After reaction of the second reducing stream with the first gas in the second reaction zone of the reactor, a second gas 26 comprising the synthesis gas is recovered at the outlet of the reactor 28.

The second reducing stream 24 comprises at least one hydrocarbon as a second carbon source, and the generation of the synthesis gas, in the second reaction zone 14, is carried out in part by steam reforming of the hydrocarbon(s) with the water vapor included in the first gas and/or any water vapor present in the reducing stream 24 as mentioned above. This carbon source can be a fossil or renewable hydrocarbon, preferably methane or fossil or renewable natural gas (RNG). In some embodiments, the second carbon source is methane derived from biogas. In the case where a hydrocarbon which is methane is used, reaction (E), and reaction (F) in the presence of residual CO₂, occur in the second zone 14.

CH₄+H₂O→CO+3H₂ (E)

CH₄+CO₂→2 CO+2H₂ (F)

By steam reforming of the hydrocarbon(s) fed into the second zone, a synthesis gas meeting the criteria presented by equations (C) and (D) can be obtained.

As explained above, hydrogen may also be supplied to the second zone 14 to produce the synthesis gas. When additional hydrogen is supplied to zone 14 by the reducing stream 24, on one hand the composition of the synthesis gas can be balanced in order to comply with equations (C) and (D) as mentioned above, and, on the other hand, water vapor and residual CO₂ can be reduced in this zone.

In addition, the molar proportions of CO and H₂ in the synthesis gas can also be varied by supplying the second zone 14 with both one or more hydrocarbons and hydrogen.

According to some embodiments, the hydrogen which is fed via the second reducing stream 24 in the second zone 14 may be blue hydrogen as described above, i.e., hydrogen resulting from a steam reforming reaction of natural gas or methane in a process for which the CO₂ generated is at least partly captured and sequestered.

According to some embodiments, the second reducing stream 24 may comprise methane (CH₄) and optionally hydrogen (H₂) in a H₂/CH₄ molar ratio of between 0 and 2.5.

According to another embodiment, the second zone can be supplied with a second reducing stream 24 comprising methane (CH₄) and optionally hydrogen (H₂), such that the molar ratio between the CH₄ supplied and a total quantity of H₂ supplied in the two zones is between 0.1 and 1.

It should be noted that in some embodiments, the second reducing stream 24 may contain, in addition to the inputs described above, water vapor and a small quantity of impurities.

According to some embodiments, the reducing stream 24 fed into the second zone 14 may comprise methane (CH₄) and optionally water vapor (H₂O) with a molar ratio of water vapor (H₂O) to CH₄ which may be between 0 and 2.

According to some embodiments, the reducing stream 24 fed into the second zone 14 may further comprise organic compounds derived from biomass, i.e., comprising biogenic carbon. These organic compounds comprising biogenic carbon may have the formula C_{α}H_{β}O_{γ} with α varying from 1 to 5, β varying from 2 to 10, and γ varying from 1 to 4.

According to some embodiments, the reaction in the second zone 14 of the reactor is carried out at a temperature which is lower than the temperature in the first zone 12. In some embodiments, the synthesis gas can be generated in the second zone 12 at a temperature of at least 700° C. and at most 1500° C. In some cases, the temperature in the second reaction zone may be between about 700° C. and about 1000° C. Thus, the temperature in the second reaction zone can also be between about 700° C. and about 1400° C., between about 700° C. and about 1300° C., between about 700° C. and about 1200° C., between about 700° C. and about 1100° C., between about 700° C. and about 1000° C., between about 700° C. and about 900° C., or between about 700° C. and about 800° C. It is possible to achieve a lower temperature in the second zone 14 in various ways, for example by adjusting the insulation and/or the heating or cooling system of the reactor. In some embodiments, the desired temperature can be achieved in the second reaction zone 14 by using a wall that is less insulated than, for example, the reactor wall in the first zone. It is also possible, in some cases, to use a cooling system to achieve the desired temperature in the second zone of the reactor.

According to some embodiments, the production of synthesis gas in the second zone 14 of the reactor can be carried out in the absence of catalysts such as solid catalysts (e.g., metal catalysts) as conventionally used.

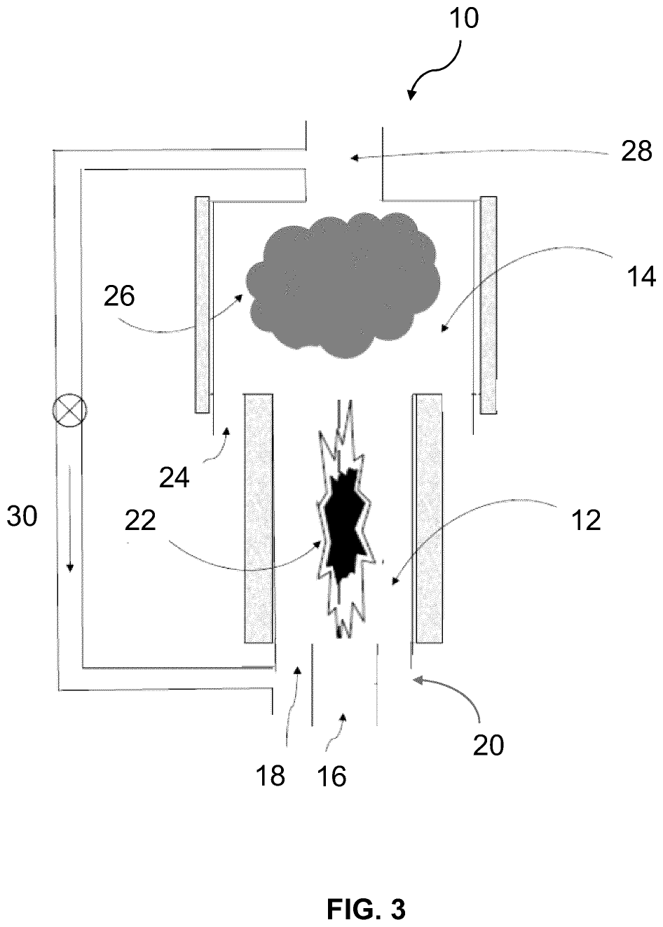

With the use of the second reaction zone 14, the quantity of water vapor resulting from the reaction taking place in the first zone 12 and the quantity of water vapor optionally present in the stream 24 fed into this second zone are substantially reduced. This is an important advantage. In addition, in some embodiments, if CO₂ remains in zone 14 as a result of the reactions occurring therein, and it is preferable to reduce it further, a return loop 30 as shown in FIG. 3, can be activated to return a portion of the gas generated in the second zone 14 to the first zone 12 of the reactor. According to some embodiments, the recycled portion of the second gas may be mixed with the first reducing stream 18 prior to being fed to the first zone 12. In addition, the recycled portion of the second gas may be cooled at the reactor outlet 28 before being returned to the first zone. According to some embodiments, the cooling must allow over-pressurization of the gas at outlet 28 using a fan.

According to a particular embodiment, the production of synthesis gas according to the present method may comprise feeding, into the first zone 12, an oxidizing stream 16 comprising oxygen and a renewable carbon source and a first reducing stream 18 comprising green hydrogen, and, in the second zone 14, feeding blue hydrogen and a fossil carbon source. If the renewable carbon source is CO₂ and the fossil carbon source is methane, the reactions involved can enable the production synthesis gas efficiently and at low cost. Equation (G) below shows a typical overall reaction scheme that can be achieved:

½O₂+H₂(green)+CO₂(renewable)+2CH₄(fossil)+H₂(blue)→3(CO+2H₂) (G)

Considering that, although the method can use fossil carbon sources as inputs, it also uses CO₂ as an input, the net GHG emissions from the reactor can be zero or very close to zero; this method can be considered as a carbon capture and utilization (CCU) method.

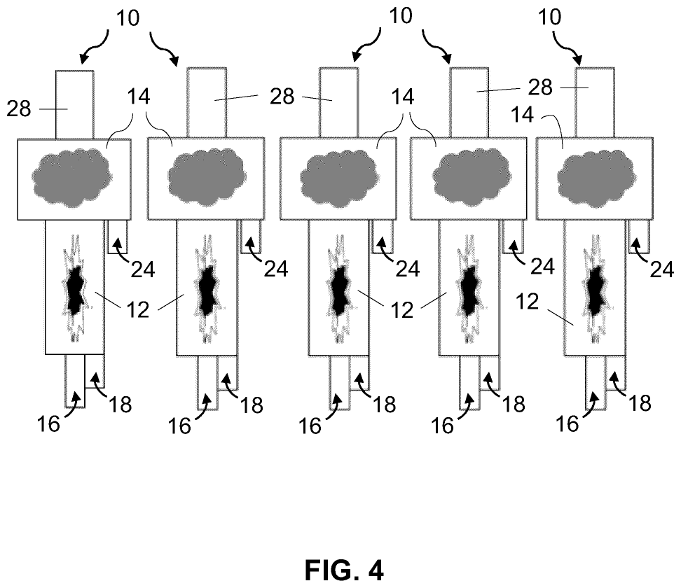

A schematic representation of a reactor that can be used to implement the present method is shown in FIGS. 1 to 3. However, the reactor design may vary and/or a system comprising several reactors may be used. Further examples of designs are shown in FIGS. 4 to 7, which will be discussed below. However, the design of the reactor or system is not limited to the representations in FIGS. 1 to 7, and this design can be adjusted as long as it enables the reactions involved in the production of synthesis gas to be carried out, within the parameters described above.

In some embodiments, a cylindrically shaped reactor may be used which comprises two reaction zones, as described above. In some embodiments, each of the two zones may itself be cylindrical.

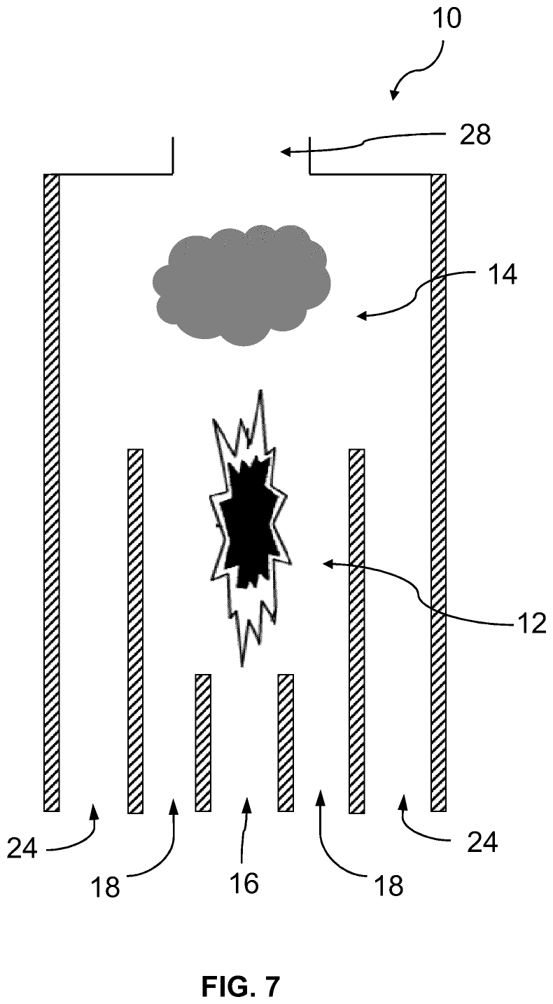

Reactor 10 may comprise a first means for feeding the oxidizing stream 16 into a lower, central part of the first zone 12 and a second means for feeding the first reducing stream 18 into the lower part of the first zone at the periphery of the oxidizing stream. In some embodiments, the reactor may comprise a first central tube through which the oxidizing stream 16 is fed into the first zone 12 and an annular space extending perpendicularly between an outer wall of the central tube and an inner wall of the first zone 12 for feeding the first reducing stream 18. In addition, the reactor may comprise a third means for feeding the second reducing stream 24 into the second zone 14. In some embodiments, this third means may consist of an opening formed by an annular space extending between an outer wall of the first zone 12 and an inner wall of the second zone 14. According to some embodiments, the annular space through which the second reducing stream 24 is fed into the reactor may extend between the outer wall of the first zone 12 and the inner wall of the second zone 14 in an upper region of the first zone and a lower region of the second zone. In some embodiments, the inlets to each of the streams 16, 18 and 24 may be at the same level as shown in FIG. 7, for example. The reactor may also comprise an outlet 28 in an upper part of the second zone 14 to recover the gas formed in the second zone which comprises the synthesis gas. In addition, as mentioned above, the reactor may be equipped with a return loop 30 (FIG. 3) to optionally return a portion of the gas formed in the second zone 14.

According to another embodiment, the production of the synthesis gas can be carried out using a plurality of reactors positioned in parallel, as shown in FIG. 4. Each of the reactors can correspond to one of the reactors shown in FIGS. 1 to 3, for example. However, the reactors in FIG. 4 can have a different design as long as each reactor has a first zone where the oxidizing stream and the first reducing stream are fed to produce the first gas, and a second zone where the second reducing stream is fed to generate the second gas comprising the synthesis gas, according to the parameters and conditions described above.

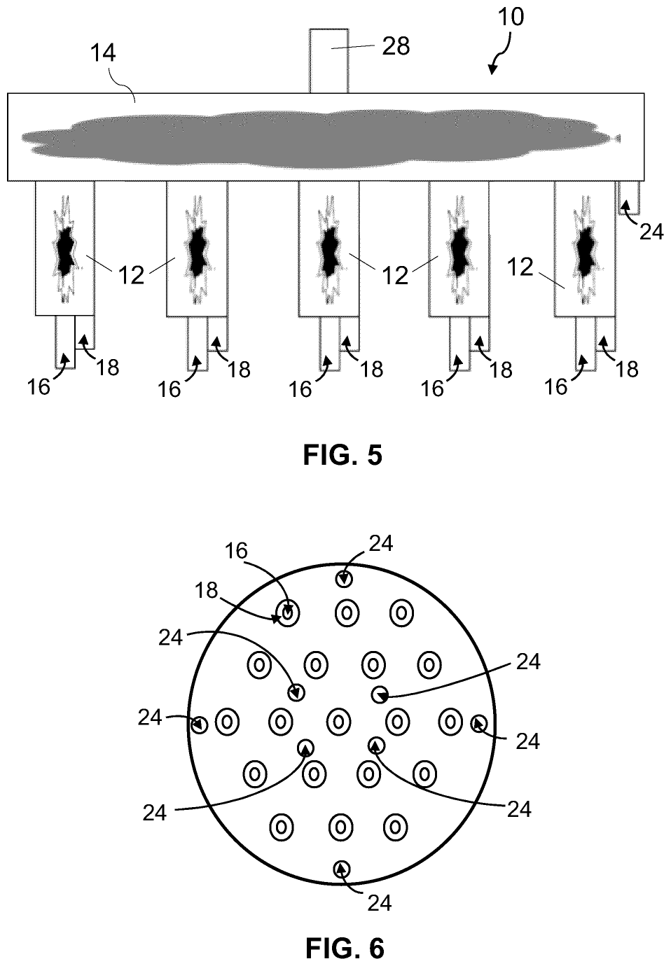

According to yet another embodiment, the production of synthesis gas can be carried out using a reactor comprising a plurality of first zones 12 and a shared second zone 14 (FIGS. 5 and 6). More particularly, in this embodiment, each first zone 12 of the reactor is fed by the oxidizing stream and the first reducing stream to produce the first gas in each first zone, and the shared second zone 14 is fed by the second reducing stream 24 and receives the first gas produced in each first zone to generate the second gas in the shared second zone. In this way, the first zones 12 operate in parallel and each comprises an oxy-flame. According to some embodiments, the second reducing stream 24 may be fed into the shared second zone 14 via at least one inlet which may be located in a peripheral zone of the second zone. However, several inlets may be provided to feed the second reducing stream 24 into the second zone. For example, inlets may be provided at several locations in a peripheral zone of the second zone and close to the lower part of its inner wall.

The synthesis gas obtained from the reactor outlet is generally cooled and then used in a subsequent chemical synthesis. The method described herein can produce synthesis gases based on CO and H₂ that are balanced, i.e., with appropriate proportions of CO and H₂, to then allow the production of a variety of products by conventional chemical syntheses. Thus, by controlling the nature and quantity of the reagents used (e.g., the flow rate of the gas streams), it is possible to produce a synthesis gas in which the proportion of CO and H₂ is adapted so that the mixture can be used in a subsequent chemical synthesis. It is also possible to influence the proportion of CO and H₂ in the synthesis gas by controlling the temperature and eventually the pressure in each reaction zone of the reactor. This pressure is generally around atmospheric pressure and can typically vary between 1 and 5 bars (absolute pressure), for each zone. According to some embodiments, the absolute pressure in the first zone may range from 1 to 5 bars, or from 1 to 4 bars, or from 1 to 3 bars, or from 1 to 2 bars. The absolute pressure in the first zone may be about 1 bar, about 2 bars, about 3 bar, about 4 bar, about 5 bars, or any pressure value in between these values. According to some embodiments, the absolute pressure in the second zone may be from 1 to 5 bars, or from 1 to 4 bars, or from 1 to 3 bars, or from 1 to 2 bars. The absolute pressure in the second zone may be about 1 bar, about 2 bars, about 3 bars, about 4 bars, about 5 bars, or any pressure value between these values. In some embodiments, the pressure in the first zone and the pressure in the second zone are very close or even the same.

In some embodiments, the synthesis gas produced by the present method can be used to produce a large number of basic chemical products and fuels. These products include methanol and hydrocarbons such as those found in motor gasoline, diesel, kerosene, to name a few examples. In some embodiments, the synthesis gas produced by the present method is used as a reducing agent for the metallurgical industry, inter alia, for the direct reduction of metal oxides, in particular iron oxides.

The synthesis gas production method described above and the reactor that can be used to carry out this method therefore have several advantages. The reagents are readily available and can be derived from renewable sources and the method is simple to implement. There is no need to use solid catalysts. It is possible to use hydrogen from a variety of sources and it is therefore possible to reduce costs by using hydrogen produced at lower cost. It is possible to use hydrogen with a low carbon footprint (e.g. green, blue, turquoise and/or pink hydrogen). So, if green hydrogen is produced at a higher cost than blue hydrogen, for example, the amount of green hydrogen used in the method can be reduced by using blue hydrogen in addition to green hydrogen, or simply by using only blue hydrogen. The method also takes advantage of the water vapor generated during CO₂ reduction, using it to produce the synthesis gas. This avoids the need to condense a large quantity of water, as is the case with other known methods, and avoids an indirect loss of hydrogen via the water vapor. The method has a beneficial environmental effect by recycling CO₂ while allowing the efficient conversion of other carbon sources such as fossil hydrocarbons, such as methane. Finally, the method provides a significant overall conversion of the carbon entering the reactor into CO, while being flexible through the relative and in situ conversions of CO₂ and hydrocarbon(s).

### EXAMPLES

As examples, laboratory tests have been carried out to demonstrate the concept proposed in this application. These examples are based on a set-up similar to that shown in FIG. 7. The inputs to each of the streams 16, 18 and 24 are physically at the same level. Streams 16 and 18 define the first reaction zone while stream 24 defines the second reaction zone, the latter at the periphery of the first reaction zone.

The reactor consists of an external alumina tube (99.8% Al₂O₃) with an internal diameter of 13.54 mm and an external diameter of 19.05 mm over a length of 212 mm. The reaction volume is 33 cm³. The gases enter through three spaces, a central space and two annular spaces defined by the ends of two concentric alumina tubes: a central tube and a medial tube. These two concentric tubes have the following dimensions respectively: an internal diameter of 6.31 mm with an external diameter of 4.11 mm for the central tube, and an internal diameter of 8.48 mm with an external diameter of 12.34 mm for the medial tube. The end of the central tube defines the path of the oxidizing stream 16 of the first zone of the reactor, while the annular space between the external diameter of the central tube and the internal diameter of the medial tube defines the path of the reducing stream 18 of the first reaction zone. Finally, the annular space between the inner diameter of the outer tube and the outer diameter of the medial tube defines the path of the second reducing stream of the second reaction zone 24.

The outer alumina tube, which defines the wall of the reaction chamber, is itself surrounded—along the entire length of the reactor—by a calcium silicate-based insulating jacket (thermal conductivity 0.3 W/m·K, density 1.36 g/cm³) of cylindrical shape with an external diameter of 132 mm and an internal diameter of 20 mm (not shown in FIG. 7). The purpose of the insulating jacket is to provide a degree of thermal insulation for the reactor in order to minimize heat loss.

In each of these examples, oxygen is mixed with CO₂ and this mixture forms the oxidizing stream 16 of the first reaction zone. In the examples, the fed hydrogen forms the reducing stream 18 of the first zone. In the first and third examples, methane is fed to form the reducing stream 24 of the second zone, whereas in the second example, a mixture of methane and water vapor forms the reducing stream 24 of the second zone. The methane-water vapor mixture is produced by a device for hot saturation of the methane flow in the presence of a controlled flow of water.

Each of the examples is shown in Table 1. In this table, for each of the gases supplied, the number of the gas stream in question (16, 18 or 24) is given in brackets, alongside the volume flow rate of that gas (sL/min, i.e., the flow rate at 25° C., 1 atm). A sample of the gas leaving the reactor is dried by rapid cooling (to −1° C.) before being sent to a mass spectrometry analysis system. Gas analysis is therefore performed on a dry basis.

The table shows the analysis of the gas leaving the reactor as determined by mass spectrometry. From the volume composition of the gas, the ratio S equal to (H₂—CO₂)/(CO+CO₂) is calculated based on the respective volume fraction of each of the gases H₂, CO₂ and CO in the dry gas obtained. The methane and CO₂ conversion rates are calculated from atomic balances and from the composition of the gas (dry basis) as obtained from gas analysis by mass spectrometry. The table also shows the rate of conversion to CO of the total carbon entering the reactor, i.e., the carbon contained in the CO₂ fed plus the carbon contained in the CH₄ fed.

The table also shows the temperature as measured using a thermocouple located 25 mm from reactor outlet 28. The measured temperature value is used to calculate the average residence time of the reactants (i.e., all the gases fed) in the reactor, based on the reaction volume as described above and considering that the reactor is operating at atmospheric pressure.

It should be noted that no measurable quantities of carbon were observed in the reactor after the tests.

Table 1 presents the results obtained for each of the two examples.

TABLE 1

| | Example 1 | | Example 2 | | Example 3 | |
|---|---|---|---|---|---|---|
| Feed | | | | | | |
| CO₂ | 1 | sL/min (16) | 0.5 | sL/min (16) | 1 | sL/min (16) |
| H₂ | 6 | sL/min (18) | 6 | sL/min (18) | 9 | sL/min (18) |
| O₂ | 3 | sL/min (16) | 3 | sL/min (16) | 3 | sL/min (16) |
| H₂O (vapor) | 0 | | 0.5 | sL/min (24) | 0 | |
| CH₄ | 2.5 | sL/min (24) | 2.5 | sL/min (24) | 2.5 | sL/min (24) |

| Dry gas composition | | | | | |
|---|---|---|---|---|---|
| CO₂ | 7.0% | vol. | 4.90% | vol. | 3.70% |
| H₂ | 60.2% | vol. | 66.4% | vol. | 68.3% |
| CO | 27.2% | vol. | 24.1% | vol. | 21.4% |
| O₂ | negligible | | negligible | | negligible |
| CH₄ | 5.6% | vol. | 4.5% | vol. | 6.60% |

| | | | |
|---|---|---|---|
| S = (H₂ − CO₂)/(CO + CO₂) | 1.55 | 2.12 | 2.57 |
| Conversion rate - CH₄ | 79% | 83% | 70% |
| Conversion rate - CO₂ | 33% | 5.5% | 58% |
| Conversion rate of total | 74.1% | 77.4% | 70% |
| input carbon to CO | | | |
| Temperature - outlet (° C.) | 921 | 895 | 940 |
| Residence time (s) | 0.032 | 0.037 | 0.028 |

The results of examples 1, 2 and 3, as shown in Table 1, demonstrate the flexibility of the method and system according to the present description. This flexibility results essentially from the geometric distinction of the reactive zones in the reactor. In particular, the configuration used in these examples (see FIG. 7) offers the advantage of obtaining a fairly wide and flexible range of relative and in situ conversions of CH₄ and CO₂, while ensuring a significant overall conversion of the carbon entering the reactor (of at least 70%).

The results of examples 1 and 2 show that the supply of water vapor is not critical for achieving high methane conversion. In fact, adding water to the second zone only slightly increases the conversion of methane (from 79% to 83%) (by reaction (E)) but leads to a reduction in the conversion of CO₂, probably by favouring the reverse of reaction (A). The results of example 3 show that a high and equivalent conversion of CH₄ and CO₂ can be achieved by adding a certain amount of excess hydrogen in the first zone (9 vs. 6 sL/min). Indeed, this excess hydrogen seems to help convert CO₂ more efficiently in the first zone by reaction (A)). In this same example 3, it is observed that the conversion of CH₄ is not significantly affected by the increase in the conversion of CO₂ due to the fact that this CH₄ is fed separately into the second zone.

Although some embodiments of the technology have been described above, the technology is not limited to these sole embodiments. Several modifications could be made to any of the embodiments described above without departing from the scope of the present technology as contemplated.

1- A method for producing synthesis gas comprising carbon monoxide (CO) and hydrogen (H₂), the method comprising:
feeding an oxidizing stream comprising oxygen (O₂) and a first reducing stream comprising hydrogen (H₂) into at least a first reaction zone of at least one reactor, where the oxidizing stream and/or the first reducing stream further comprises a first carbon source which is CO₂;
generating an oxy-flame in the first zone by reaction between the oxygen of the oxidizing stream and the hydrogen of the first reducing stream, and producing a first gas comprising at least carbon monoxide (CO) and water vapor (H₂O) by contacting the oxidizing stream and the first reducing stream with the oxy-flame;
feeding into the reactor a second reducing stream comprising a second source of carbon comprising at least one hydrocarbon;
generating in a second reaction zone of the reactor of a second gas comprising the synthesis gas, from the first gas coming from the first reaction zone and the second reducing stream by a reaction involving the hydrocarbon.

2- The method according to claim 1, wherein the oxidizing stream comprises oxygen and CO₂.

3- The method according to claim 1, wherein the first reducing stream comprises hydrogen (H₂) and CO₂, and optionally water vapor in a H₂O/H₂ ratio from 0 to 1, preferably in a H₂O/H₂ ratio from 0 to 0.5.

4- The method according to claim 1, wherein the oxidizing stream and the first reducing stream each comprise CO₂.

5- The method according to claim 1, wherein only the oxidizing stream comprises CO₂.

6- The method according to any one of claims 1 to 5, wherein the CO₂ comes from an industrial waste, is biogenic CO₂ from biogas, is CO₂ captured directly from ambient air or a mixture thereof.

7- The method according to any one of claims 1 to 6, wherein the hydrogen present in the first reducing stream results from a water electrolysis reaction.

8- The method according to any one of claims 1 to 6, wherein the hydrogen present in the first reducing stream results from a water electrolysis reaction in an electrolyzer which is powered by electricity produced from a renewable source (e.g. produced from solar energy, wind energy, hydraulic energy, biomass or geothermal energy) or nuclear energy.

9- The method according to any one of claims 1 to 6, wherein the hydrogen present in the first reducing stream results from a steam reforming reaction of natural gas or methane in a process in which the CO₂ generated is at least partly captured and sequestered.

10- The method according to any one of claims 1 to 6, wherein the hydrogen present in the first reducing stream comprises hydrogen resulting from a methane pyrolysis reaction.

11- The method according to any one of claims 1 to 6, wherein the hydrogen present in the first reducing stream comprises hydrogen resulting from a water electrolysis reaction in an electrolyzer which is powered by electricity produced from a renewable source (e.g., produced from solar energy, wind energy, hydraulic energy, biomass or geothermal energy) or nuclear energy, and hydrogen resulting from a steam reforming reaction of natural gas or methane in a process for which the CO₂ generated is at least partly captured and sequestered.

12- The method according to any one of claims 8, 9 and 11, wherein the hydrogen present in the first reducing stream further comprises hydrogen resulting from a methane pyrolysis reaction.

13- The method according to any one of claims 1 to 12, wherein the hydrogen, oxygen and CO₂ are fed in the first zone in a H₂/O₂ molar ratio of at least 2, and a H₂/CO₂ molar ratio of least 1.8.

14- The method according to any one of claims 1 to 12, wherein the hydrogen, oxygen and CO₂ are fed in the first zone in a H₂/O₂ molar ratio of between 2 and 10, and a H₂/CO₂ molar ratio of between 1.8 and 9.

15- The method according to any one of claims 1 to 14, wherein the oxygen and CO₂ are fed in the first zone in a O₂/CO₂ molar ratio of at least 0.5.

16- The method according to any one of claims 1 to 14, wherein the oxygen and CO₂ are fed in the first zone in a O₂/CO₂ molar ratio of between 0.5 and 6.

17- The method according to any one of claims 1 to 16, wherein generating the synthesis gas comprises steam reforming the hydrocarbon(s) with the water vapor comprised in the first gas.

18- The method according to any one of claims 1 to 17, wherein the second reducing stream further comprises water vapor and the generation of the synthesis gas comprises steam reforming of the hydrocarbon(s) with the water vapor comprised in the first gas and the water vapor comprised in the second reducing stream.

19- The method according to any one of claims 1 to 18 wherein the second carbon source comprises a fossil or renewable hydrocarbon.

20- The method according to any one of claims 1 to 18, wherein the second carbon source comprises fossil or renewable natural gas.

21- The method according to any one of claims 1 to 18, wherein the second carbon source comprises methane.

22- The method according to any one of claims 1 to 18, wherein the second carbon source comprises methane from a biogas.

23- The method according to any one of claims 1 to 22, wherein the second reducing stream further comprises an organic compound derived from biomass.

24- The method according to any one of claims 1 to 23, wherein the second reducing stream further comprises a compound of formula C_{α}H_{β}O_{γ} with α varying from 1 to 5, β varying from 2 to 10 and γ varying from 1 to 4.

25- The method according to any one of claims 1 to 24, wherein the second reducing stream comprises methane (CH₄) and optionally hydrogen (H₂) in a H₂/CH₄ molar ratio of between 0 and 2.5.

26- The method according to any one of claims 1 to 25, wherein the second reducing stream comprises methane (CH₄) and optionally hydrogen (H₂) and a molar ratio between the CH₄ fed and a total amount of H₂ fed in the two zones is between 0.1 and 1.

27- The method according to any one of claims 1 to 26, wherein the second reducing stream further comprises hydrogen (H₂).

28- The method according to claim 27, wherein the hydrogen present in the second reducing stream results from a steam reforming reaction of natural gas or methane in a process in which the CO₂ generated is at least partly captured and sequestered.

29- The method according to claim 27 or 28, wherein the second reducing stream comprises a quantity of hydrogen to balance the molar composition of the synthesis gas to have H₂/CO≥2 and (H₂—CO₂)/(CO+CO₂)≥2.

30- The method according to any one of claims 1 to 29, wherein the second reducing stream comprises methane (CH₄) and optionally water vapor (H₂O), and a molar ratio of water vapor (H₂O) to CH₄ is between 0 and 2.

31- The method according to any one of claims 1 to 30, wherein the second reducing stream further comprises water vapor.

32- The method according to any one of claims 1 to 31, wherein the production of the first gas comprising at least carbon monoxide (CO) and water vapor (H₂O), in the first zone, is carried out at a temperature of at least 1000° C. and at most 2400° C.

33- The method according to any one of claims 1 to 32, wherein the production of the first gas comprising at least carbon monoxide (CO) and water vapor (H₂O), in the first zone, is carried out at a temperature of between about 1000° C. and about 1900° C.

34- The method according to any one of claims 1 to 33, wherein generating the synthesis gas, in the second zone, is carried out at a temperature of at least 700° C. and at most 1500° C.

35- The method according to any one of claims 1 to 34, wherein generating the synthesis gas, in the second zone, is carried out at a temperature of between about 700° C. and about 1000° C.

36- The method according to any one of claims 1 to 35, wherein generating the synthesis gas, in the second zone, is carried out at a temperature lower than a temperature in the first zone.

37- The method according to any one of claims 1 to 36, wherein the production of carbon monoxide and water vapor in the first zone is carried out in the absence of a catalyst.

38- The method according to any one of claims 1 to 37, wherein the generation of the second gas comprising the synthesis gas in the second zone of the reactor is carried out in the absence of a catalyst.

39- The method according to any one of claims 1 to 38, wherein the oxygen (O₂) present in the oxidizing stream results from a water electrolysis reaction.

40- The method according to any one of claims 1 to 39, wherein the oxygen (O₂) present in the oxidizing stream comes from an air separation unit (ASU).

41- The method according to any one of claims 1 to 40, wherein the oxidizing stream is fed into a lower, central part of the first zone and the first reducing stream is fed into the lower part of the first zone at the periphery of the oxidizing stream.

42- The method according to any one of claims 1 to 41, wherein the second gas generated in the second zone comprises synthesis gas and residual CO₂ and the method further comprises recycling a portion of the second gas to the first zone.

43- The method according to claim 42, wherein the portion of the second gas is recycled in the first reducing stream.

44- The method according to claim 42 or 43, further comprising cooling the portion of the second gas to be recycled, prior to recycling.

45- The method according to any one of claims 1 to 44, wherein the method is carried out in a plurality of reactors in parallel, each reactor having the first zone which receives the oxidizing stream and the first reducing stream and where the first gas is produced, and the second zone which receives the second reducing stream and where the second gas is generated.

46- The method according to any one of claims 1 to 44, wherein the reactor comprises a plurality of first zones and a shared second zone, and wherein:
the oxidizing stream and the first reducing stream are fed to each first zone of the plurality of first zones and the first gas is produced in each first zone,
the second reducing stream is fed to the shared second zone that received the first gas produced in each first zone and the second gas is generated in the shared second zone.

47- A system for producing a synthesis gas comprising carbon monoxide (CO) and hydrogen (H₂), the system comprising at least one reactor and said reactor comprising at least one first reaction zone and at least one second reaction zone, wherein:
the first reaction zone is fed with an oxidizing stream comprising oxygen (O₂) and a first reducing stream comprising hydrogen (H₂), where the oxidizing stream and/or the first reducing stream further comprises a first carbon source which is CO₂, and in the first zone an oxy-flame is generated by reaction between the oxygen of the oxidizing stream and the hydrogen of the first reducing stream, to produce a first gas comprising at least carbon monoxide (CO) and water vapor (H₂O) by contacting the oxidizing stream and the first reducing stream with the oxy-flame;
the second reaction zone is fed with a second reducing stream comprising a second carbon source comprising at least one hydrocarbon, to generate in the second reaction zone a second gas comprising the synthesis gas from the first gas coming from the first reaction zone and the second reducing stream by a reaction with the hydrocarbon.

48- The system according to claim 47, wherein the oxidizing stream comprises oxygen and CO₂.

49- The system according to claim 47, wherein the first reducing stream comprises hydrogen (H₂) and CO₂, and optionally water vapor in a H₂O/H₂ ratio from 0 to 1, preferably in a H₂O/H₂ ratio from 0 to 0.5.

50- The system according to claim 47, wherein the oxidizing stream and the first reducing stream each comprise CO₂.

51- The system according to claim 47, wherein only the oxidizing stream comprises CO₂.

52- The system according to any one of claims 47 to 51, wherein the CO₂ comes from an industrial waste, is biogenic CO₂ from biogas, is CO₂ captured directly from ambient air or a mixture thereof.

53- The system according to any one of claims 47 to 52, wherein the hydrogen present in the first reducing stream results from a water electrolysis reaction.

54- The system according to any one of claims 47 to 52, wherein the hydrogen present in the first reducing stream results from a water electrolysis reaction in an electrolyzer which is powered by electricity produced from a renewable source (e.g., produced from solar energy, wind energy, hydraulic energy, biomass or geothermal energy) or nuclear energy.

55- The system according to any one of claims 47 to 52, wherein the hydrogen present in the first reducing stream results from a steam reforming reaction of natural gas or methane in a process in which the CO₂ generated is at least partly captured and sequestered.

56- The system according to any one of claims 47 to 52, wherein the hydrogen present in the first reducing stream comprises hydrogen resulting from a methane pyrolysis reaction.

57- The system according to any one of claims 47 to 52, wherein the hydrogen present in the first reducing stream comprises hydrogen resulting from a water electrolysis reaction in an electrolyzer which is powered by electricity produced from a renewable source (e.g., produced from solar energy, wind energy, hydraulic energy, biomass or geothermal energy) or nuclear energy, and hydrogen resulting from a steam reforming reaction of natural gas or methane in a process for which the CO₂ generated is at least partly captured and sequestered.

58- The system according to any one of claims 54, 55 and 57, wherein the hydrogen present in the first reducing stream further comprises hydrogen resulting from a methane pyrolysis reaction.

59- The system according to any one of claims 47 to 58, wherein the hydrogen, oxygen and CO₂ are fed in the first zone in a H₂/O₂ molar ratio of at least 2, and a H₂/CO₂ molar ratio of least 1.8.

60- The system according to any one of claims 47 to 58, wherein the hydrogen, oxygen and CO₂ are fed in the first zone in a H₂/O₂ molar ratio of between 2 and 10, and a H₂/CO₂ molar ratio of between 1.8 and 9.

61- The system according to any one of claims 47 to 60, wherein the oxygen and CO₂ are fed in the first zone in a O₂/CO₂ molar ratio of at least 0.5.

62- The system according to any one of claims 47 to 60, wherein the oxygen and CO₂ are fed in the first zone in a O₂/CO₂ molar ratio of between 0.5 and 6.

63- The system according to any one of claims 47 to 62, wherein generation of the synthesis gas comprises steam reforming the hydrocarbon(s) with the water vapor comprised in the first gas.

64- The system according to any one of claims 47 to 63, wherein the second reducing stream further comprises water vapor and the generation of the synthesis gas comprises steam reforming of the hydrocarbon(s) with the water vapor comprised in the first gas and the water vapor comprised in the second reducing stream.

65- The system according to any one of claims 47 to 64, wherein the second carbon source comprises a fossil or renewable hydrocarbon.

66- The system according to any one of claims 47 to 64, wherein the second carbon source comprises fossil or renewable natural gas.

67- The system according to any one of claims 47 to 64, wherein the second carbon source comprises methane.

68- The system according to any one of claims 47 to 64, wherein the second carbon source comprises methane from a biogas.

69- The system according to any one of claims 47 to 68, wherein the second reducing stream further comprises an organic compound derived from biomass.

70- The system according to any one of claims 47 to 69, wherein the second reducing stream further comprises a compound of formula C_{α}H_{β}O_{γ} with α varying from 1 to 5, β varying from 2 to 10 and γ varying from 1 to 4.

71- The system according to any one of claims 47 to 70, wherein the second reducing stream comprises methane (CH₄) and optionally hydrogen (H₂) in a H₂/CH₄ molar ratio of between 0 and 2.5.

72- The system according to any one of claims 47 to 71, wherein the second reducing stream comprises methane (CH₄) and optionally hydrogen (H₂) and a molar ratio between the CH₄ fed and a total amount of H₂ fed in the two zones is between 0.1 and 1.

73- The system according to any one of claims 47 to 72, wherein the second reducing stream further comprises hydrogen (H₂).

74- The system according to claim 73, wherein the second reducing stream comprises hydrogen resulting from a steam reforming reaction of natural gas or methane in a process in which the CO₂ generated is at least partly captured and sequestered.

75- The system according to claim 73 or 74, wherein the second reducing stream comprises a quantity of hydrogen to balance the molar composition of the synthesis gas to have H₂/CO≥2 and (H₂—CO₂)/(CO+CO₂)≥2.

76- The system according to any one of claims 47 to 75, wherein the second reducing stream comprises methane (CH₄) and optionally water vapor (H₂O), and a molar ratio of water vapor (H₂O) to CH₄ is between 0 and 2.

77- The system according to any one of claims 47 to 76, wherein the second reducing stream further comprises water vapor.

78- The system according to any one of claims 47 to 77, wherein the first zone is at a temperature of at least 1000° C. and at most 2400° C. during the production of the first gas comprising at least carbon monoxide (CO) and water vapor (H₂O).

79- The system according to any one of claims 47 to 77, wherein the first zone is at a temperature between about 1000° C. and about 1900° C. during the production of the first gas comprising at least carbon monoxide (CO) and water vapor (H₂O).

80- The system according to any one of claims 47 to 79, wherein the second zone is at a temperature of at least 700° C. and at most 1500° C. during the production of the synthesis gas.

81- The system according to any one of claims 47 to 79, wherein the second zone is at a temperature between about 700° C. and about 1000° C. during the production of the synthesis gas.

82- The system according to any one of claims 47 to 81, wherein generating the synthesis gas, in the second zone, is carried out at a temperature lower than a temperature in the first zone.

83- The system according to any one of claims 47 to 82, wherein the production of carbon monoxide and water vapor in the first zone is carried out in the absence of a catalyst.

84- The system according to any one of claims 47 to 83, wherein the generation of the second gas comprising the synthesis gas in the second zone of the reactor is carried out in the absence of a catalyst.

85- The system according to any one of claims 47 to 84, wherein the oxygen (O₂) present in the oxidizing stream results from a water electrolysis reaction.

86- The system according to any one of claims 47 to 85, wherein the oxygen (O₂) present in the oxidizing stream comes from an air separation unit (ASU).

87- The system according to any one of claims 47 to 86, wherein the second gas generated in the second zone comprises the synthesis gas and residual CO₂ and the system further comprises means for recycling a portion of the second gas to the first zone.

88- The system according to claim 87, wherein the means for recycling comprises a duct conveying the portion of the second gas to be mixed with the first reducing stream.

89- The system according to claim 87 or 88, further comprising a device for cooling the portion of the second gas to be recycled, prior to recycling.

90- The system according to any one of claims 47 to 89, wherein the first zone and the second zone are each of cylindrical shape.

91- The system according to any one of claims 47 to 90, comprising a first means for feeding the oxidizing stream into a lower, central part of the first zone and a second means for feeding the first reducing stream into the lower part of the first zone at the periphery of the oxidizing stream.

92- The system according to claim 91, wherein the first means consists of a first central tube and the second means consists of an annular space extending perpendicularly between an outer wall of the central tube and an inner wall of the first zone.

93- The system according to any one of claims 47 to 92, comprising a third means for feeding the second reducing stream in the second zone.

94- The system according to claim 93, wherein the first zone and the second zone are each cylindrical in shape and the third means consists of an opening formed by an annular space extending between an outer wall of the first zone and an inner wall of the second zone, optionally in an upper region of the first zone and a lower region of the second zone.

95- The system according to any one of claims 47 to 94, comprising a plurality of reactors in parallel, each reactor having the first zone receiving the oxidizing stream and the first reducing stream and where the first gas is produced, and the second zone receiving the second reducing stream and where the second gas is generated.

96- The system according to any one of claims 47 to 92, wherein the reactor comprises a plurality of first zones and a shared second zone, and wherein:
each first zone of the plurality of first zones is fed by the oxidizing stream and the first reducing stream to produce the first gas in each first zone, and
the shared second zone is fed by the second reducing stream and receives the first gas produced in each first zone to generate the second gas in the shared second zone.

97- Use of a synthesis gas produced by the method as defined according to any one of claims 1 to 46 or by the system as defined according to any one of claims 47 to 96, for the manufacture of chemical products or fuels.

98- The use according to claim 97, for the manufacture of synthetic hydrocarbons.

99- Use of a synthesis gas produced by the method as defined according to any one of claims 1 to 46 or by the system as defined according to any one of claims 47 to 96, as a reducing agent in the metallurgical industry.

100- Use of a system as defined according to any one of claims 47 to 96 for the treatment of gaseous industrial effluents containing CO₂.
